(19) United States
(12) Patent Application Publication
(10) Pub. No.: US 2019/0044721 A1
(43) Pub. Date: Feb. 7, 2019

(54) DEVICE AUTHORIZATION USING SYMMETRIC KEY SYSTEMS AND METHODS

(71) Applicant: Rubicon Labs, Inc., San Francisco, CA (US)

(72) Inventors: Roderick Schultz, San Francisco, CA (US); Gerald E. Woodcock, III, Austin, TX (US)

(21) Appl. No.: 15/838,020

(22) Filed: Dec. 11, 2017

Related U.S. Application Data
(63) Continuation-in-part of application No. 15/667,476, filed on Aug. 2, 2017.

(51) Int. Cl. H04L 9/32; H04L 29/06; H04L 9/08; H04L 9/00

(52) U.S. Cl. CPC H04L 9/321; H04L 63/0838; H04L 9/0861; H04L 63/062; H04L 9/3236; H04L 63/0435; H04L 9/3228; H04L 9/006

(57) ABSTRACT

Authorization using symmetric key systems and methods are disclosed herein. An example method includes authenticating nodes by verifying symmetric keys that comprise a static portion and a dynamic portion of a keyed-hashing function having been cryptographically processed, each of the nodes having one of the symmetric keys, comparing the symmetric keys to values stored by a rubicon identity service, exchanging symmetric keys between the nodes when authenticated, pre-provisioning an authorization policy to the nodes, and authorizing a node of the nodes to perform an action defined within the authorization policy.

### CROSS REFERENCE TO RELATED APPLICATIONS

This application is a continuation-in-part of U.S. patent application Ser. No. 15/667,476, filed on Aug. 2, 2017, which is hereby incorporated by reference herein in its entirety, including all references and appendices cited therein, for all purposes.

### FIELD OF THE PRESENT TECHNOLOGY

The present disclosure relates to secure device communications, and more particularly, but not by way of limitation, to systems and methods that provision secure symmetric keys to devices. These symmetric keys can be utilized by the devices to effectuate secure communications. Embodiments use symmetric keys that are mirrored in a cloud service. These symmetric keys can be linked to authorization policies that allow devices to act in accordance with the authorization policies.

### SUMMARY

Various embodiments of the present technology include a method comprising: (a) authenticating nodes by: (i) verifying symmetric keys that comprise a static portion and a dynamic portion of a keyed hashing function having been cryptographically processed, each of the nodes having one of the symmetric keys; (ii) comparing the symmetric keys to values stored by a rubicon identity service; and (iii) exchanging symmetric keys between the nodes when authenticated; (b) pre-provisioning an authorization policy to the nodes; and (c) authorizing a node of the nodes to perform an action defined within the authorization policy.

Various embodiments of the present technology include a system comprising: (a) a first computing node configured to: (i) receive a request from a second computing node; (ii) forward a first timestamp in a response message to the second computing node; (iii) generate, by the second computing node, a session key using a keyed-hash message authentication code to process a first set of bits of entropy and the first timestamp; (b) the second computing node configured to: (i) transmit the first timestamp, the first set of bits of entropy, and a second set of bits of entropy to a third computing node; (c) the third computing node configured to: (i) generate, by the third computing node, an encryption session key using another keyed-hash message authentication code to process the second set of bits of entropy and a third set of bits of entropy; and (ii) transmit the encryption session key to the second computing node along the third set of bits of entropy; and (d) wherein the second computing node decrypts the session key using the encryption key and the third set of bits of entropy to recover the session key.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a signal flow diagram of an example method of the present disclosure for provisioning a plurality of secret keys to a plurality of devices, where the secret keys are mirrored in a rubicon identity service.

FIG. 2 is a flowchart of a method executed by a device that is configured for use according to embodiments of the present disclosure.

FIG. 3 is a signal flow diagram of an example method of the present disclosure that illustrates the establishment of a secure channel of communication between two devices using symmetric session key encryption and decryption.

FIG. 4 is a flowchart of a method executed by a rubicon identity service that is configured for use according to embodiments of the present disclosure.

FIG. 5 is a flowchart of a method for authentication and authorization of nodes according to embodiments of the present disclosure.

FIG. 6 is a signal flow of a method executed in accordance with the present disclosure.

FIG. 7 is a schematic diagram of a computing system that is used to implement embodiments according to the present technology.

### DETAILED DESCRIPTION

Generally, embodiments of the present disclosure are related to systems and methods that utilize symmetric keys, and specifically, symmetric keys (some embodiments utilize zero-knowledge processes) to both identify devices and establish secure channels of communication. These secure channels of communication can exist between the devices and a cloud-based service, referred to herein as a rubicon identity service, and also between authenticated devices.

Embodiments of the present disclosure provide an easily integrated key provisioning and protection platform for devices. Example devices include, but are not limited to, computing systems, telecommunications devices, sensors, automotive microcontrollers (MCUs), and central processing units (CPUs). These devices can include a minimal semiconductor footprint coupled with a hardware Root of Trust (RoT). Embodiments incorporate an on-chip solution that can fit into any secure or vulnerable computing environment such as systems within the Internet of Things (IoT).

Some embodiments of the present disclosure provide for coupling of a keyed one-way hash function with a secure memory space on the device. This coupling creates a vault that can be provisioned with a secret key whose value is never known by anyone or anything, but is still usable by the device. This process produces a self-provisioning symmetric key system that can be used as the digital identity of the device. That is, the rubicon identity service mirrors the secret key of the device. The secret key is the identity of the device within the rubicon identity service.

Some embodiments implement symmetric keys to prove an assertion without revealing any other information. It will be understood that a semiconductor-enforced sandbox is secure because the MCU/CPU can interact with the secret key in the vault only to write data to the input of the keyed-hash function (e.g., secret key) and to read the resulting output.

Thus, even if an attacker gains access the CPU/MCU, the attacker can never access the symmetrickey. The address of the secret key within the vault is never readable, keeping the identity of the device secure. Stated otherwise, the device has a secure execution space, so no root key or derived session key is ever in attackable memory.

As mentioned above, once zero-knowledge keys are provisioned into the secure execution space of a core of the device, the secure key is mirrored in a cloud-based rubicon identity service (RIS). Thus, the authenticated identity of the device is brokered through the RIS.

The RIS can be generally described as a powerful certificate authority, but the RIS is based on symmetric cryptography (not public key infrastructure (PKI)). It brokers trust relationships between devices and has a foundation of symmetric keys. These systems and methods solve a key and identity-provisioning problem that has challenged vendors, especially as deployed device numbers have grown larger. The systems of the present disclosure scale far better than asymmetric/PKI-based keys and have incredible speeds of execution, which are a requirement for many system and device bus speeds.

For example, a key exchange of the present disclosure can execute 3,000 times faster than an equivalent RSA 2048 bit TLS (Transport Layer Security) handshake. This low-power and high-speed feature is critical for many systems, such as RTOS (real-time operating system) requirements of some systems.

The systems and methods disclosed herein complement implementations that rely on secure identity by deriving session keys between other similarly constructed devices and servers. These session keys are all symmetric key based, execute in a secure execution space, and allow for authentication, data encryption, and secure execution of signed binaries that are delivered from the cloud.

In an example use case in the automotive arts, these systems and methods can prevent malicious attacks that use identity spoofing, data manipulation, code/binary replacement, and cloning—just to name a few. These attacks are possible, and even simple, due to a lack of secure identity, secure communication, and secure execution of MCUs on the CAN (controller area network) bus.

With regard to the construction of devices that are capable of using the symmetric keys of the present disclosure, each device has a one-time programmable key burned into its silicon when it is fabricated. This key represents half of a dual 256 bit symmetric hardware secret key, referred to also herein as a “keyed hashing function”. The one-time programmable key is referred to as a static portion of the keyed hashing function/secret key.

Secure session keys can be derived from this same structure, creating symmetric keys. A dynamic portion of the symmetric key is provisioned by contacting the RIS of the device. Once contacted, signed entropy is sent to the device and subsequently used for symmetric key derivation. In one example, the signed entropy comprises a randomly generated set of numerical characters.

Once the secret key is set the first time, the server-supplied entropy input may be saved along with its signature to a local persistent storage device. This allows the device to re-initialize the secret key on subsequent power cycles without having to communicate again with the RIS.

Device activation is designed for distributed cooperation with untrusted parties (e.g., devices). This prevents any one party from having full control of device activation and addresses any concerns with single points of compromise for cryptographic activation keys.

Distributed device activation is accomplished by building on symmetric key derivatives, along with cryptographic key splitting. No single part of the activation key can be used without assembling it from multiple independently sourced parts. A policy can be defined to allow for a threshold of keys to be available (N of M in a set) before key reconstruction is mathematically possible.

This allows a hardware vendor to have an untrusted relationship with a service provider but still enable secure activation across multiple independent security boundaries.

In some embodiments, the RIS can be leveraged as a powerful certificate authority. It brokers trust relationships between devices and has a foundation of symmetric keys. This is a simplification to the key and identity-provisioning problem that has challenged vendors as networks have grown.

Embodiments of the present disclosure are fully portable and interoperable with any CPU architecture because it secures data, not addresses. Embodiments can be built with NIST (National Institute of Standards and Technology) algorithms and do not require new CPU instructions or compilers. If an IoT device requires security, then these systems and methods are designed to provide it.

Once provisioned with a symmetric key, a secure identity is built on top of it. Identity verification and management can then be used for authentication, authorization, and secure communication.

As mentioned above, identity management can be accomplished by brokering relationships through the RIS. The RIS has the ability to recreate and use the symmetric keys it has provisioned to the individual devices. This RIS provides identity and trust to the network, and once trust has been brokered between two devices, independent and secure communication is unlocked and enabled.

These and other aspects of the present disclosure will be disclosed in greater detail below with reference to the collective drawings.

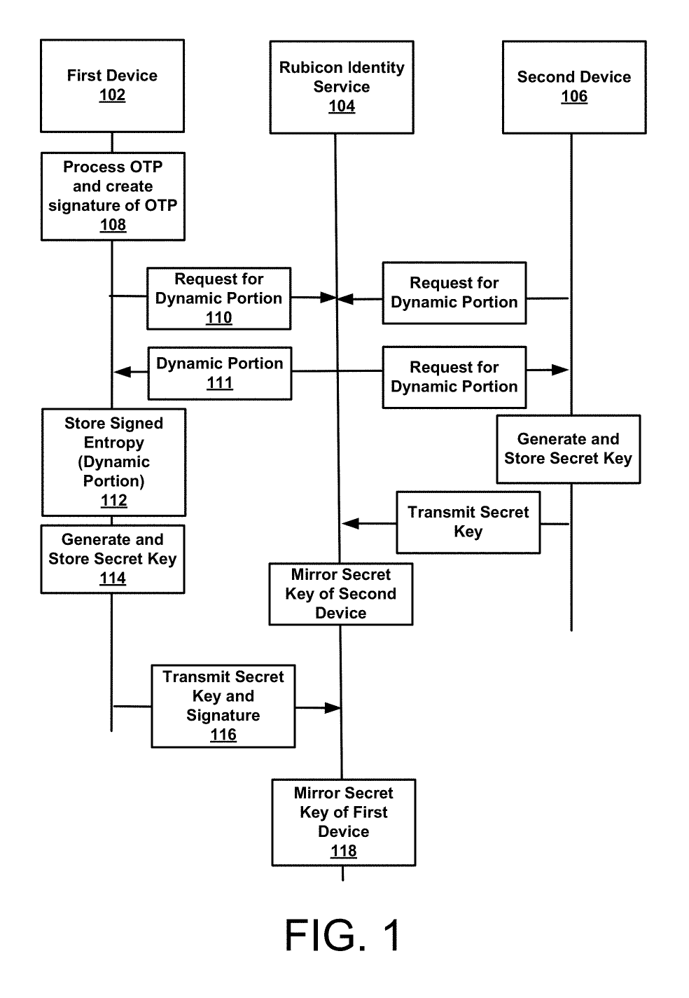

FIG. 1 illustrates an example signal flow diagram of a method for provisioning a secret key to one or more devices. The method is conducted between a first device 102, a rubicon identity service (RIS) 104, and a second device 106. The RIS 104 can mediate this method for any number of devices.

Prior to execution of the method, each device can be manufactured in such a way that a one-time programmable (OTP) key is written into a hardware component of the device. For example, an OTP key can be stored in a secure memory space of a first device 102. The OTP key is a static portion of a keyed hashing function of the first device 102. In some embodiments, the OTP is a randomly generated number generated by the RIS 104. This randomly generated value is referred to as a first value or first random number (first set of bits of entropy).

In some embodiments, the OTP is stored within an HMAC (hash-based message authentication code) function that is capable of implementing hashing functions such as SHA-1 (Secure Hash Algorithm 1), SHA-2, SHA-3, or other similar hashing functions. The OTP can include any bits of information in sizes ranging up to 256 bits or more.

In some embodiments, the first device 102 can include a step 108 of processing the OTP with the resident HMAC function to create a signature of the OTP. This creates a signature that can be used along with the OTP by the RIS 104 to verify/authenticate the first device 102. This process creates what is referred to as an HMAC secret.

In some embodiments, devices are provisioned with Advanced Encryption Standard (AES). The OTP key and AES each provide a means for accessing secure communication with the device. Possession of the OTP key and a corresponding signature allows the first device 102 to establish bilateral communication between the first device 102 and the RIS 104, while the AES allows for devices to establish bilateral communication, such as between the first device 102 and the second device 106, using symmetric session keys, as will be discussed in greater detail herein.

In general, the keyed hashing function for a device comprises two parts. A first part includes the static portion that is the OTP key. A second part is a dynamic portion that is received from the RIS 104. In one embodiment, the dynamic portion is signed entropy such as a randomly generated number created by the RIS 104.

When the first device 102 is initialized and connected to a network (can include any suitable network, public or private), the first device 102 transmits a request for the dynamic portion of the keyed hashing function to the RIS 104 in step 110 requesting the dynamic portion. This request 110 includes the HMAC secret that includes the signature of the OTP key and the OTP key.

As the RIS 104 stores a mirrored value of the OTP key and signature, the RIS 104 confirms that the OTP key is authentic and responds with the dynamic portion in step 111 of the dynamic portion. In some embodiments, the RIS 104 does not verify the authenticity of the OTP of the first device 102 and will transmit signed entropy to any device requesting such from the RIS 104. This dynamic portion of the keyed hashing value is referred to in some instances as a second random number (second set of bits of entropy) or second value.

In some embodiments, the RIS 104 creates a mirror of OTPs, keyed hashing functions, symmetric session keys, and other data generated by and for the devices using the RIS 104.

In some embodiments, the first device 102 can store the entropy input (e.g., dynamic portion) along with its signature to a local persistent storage device in step 112, in which the signed entropy is stored. Once the dynamic portion is received, the static and dynamic portions are processed by the first device 102 to create a secret key and store it in step 114, referred to also as the keyed hashing function. This keyed hashing function is a means for generating symmetric session keys. A symmetric session key is a secure key that allows the first device 102 to communicate with other symmetric key devices.

According to some embodiments, the secret key is created when the static portion and the dynamic portion, which can both include randomly generated numbers, are subjected to an XOR cipher algorithm creating a resultant value from the two numbers. The resultant XOR value is encrypted using the AES provisioned on the first device 102.

In some embodiments, the secret key can be mirrored at the RIS 104 by the first device 102 transmitting the secret key to the RIS 104 as in step 116. In another example embodiment, the RIS 104 can create the mirrored secret key using the static portion of the keyed hashing function in combination with the signed entropy generated for the first device 102. The RIS 104 mirrors the secret key of the first device in step 118.

The process executed between the first device 102 and the RIS 104 can be repeated for as many devices as necessary. For example, in a manufacturing facility that houses hundreds or thousands of independent devices, the method above can be used to create secret keys for each of the devices. It will be understood that the use of signed entropy when creating a secret key results in uniqueness of the secret key (e.g., keyed hashing function). Thus, as the secret key is bound in secure memory space of the device, the secret key can be used to identify the device within the RIS 104.

In one embodiment, the second device 106 is also provisioned with a secret key. As illustrated, the second device does not store the signed entropy (e.g., dynamic portion) of the keyed hashing function, although in some embodiments it may.

Once the secret key is established and mirrored in the RIS 104, the RIS 104 can act as an authenticated entity broker to establish secured sessions of communication by symmetric encrypted key exchange.

FIG. 2 illustrates an example method that can be executed by a device of the present disclosure. The method generally relates to a process for creating a symmetric security key. In some embodiments, the method includes an optional initial step 202 of storing the one-time programmable key in a vault on the first device. This step is optional as the device may be created with the one-time programmable key stored in hardware. Again, this storage includes storing the OTP in secured memory, which is the vault.

In some embodiments, the method can include a step 204 of processing the OTP key with an HMAC function to create a signature of the OTP key. This information can be used to authenticate the device with the RIS 104.

Next, the method comprises a step 206 of requesting from the RIS 104 the dynamic portion of the keyed hashing function. In some embodiments, this step is executed automatically when the device is connected to a network. The request can comprise the OTP key and signature generated by the first device. Possession of both of these values by the first device allows the RIS 104 to authenticate the first device 102.

The method also comprises a step 208 of receiving, from a rubicon identity service, a dynamic portion of the keyed hashing function from the rubicon identity service. Again, this can involve receiving signed entropy from the RIS 104, such as a randomly generated number.

It will be understood that the signed entropy value of the dynamic portion can be changed as desired. The RIS 104 can change the dynamic portion over time, which results in a corresponding change in the keyed hashing function. Re-provisioning the device with an updated dynamic portion of the keyed hashing function provides a means for revoking or changing services or hardware that is authorized for use on or by the device. For example, if the device is provided with a first signed entropy input and a first secret key is created, the RIS 104 can push a new or second signed entropy input down to the device. This change results in the creation of a new or updated keyed hashing value when the second signed entropy input is XOR'd with the static portion of the keyed hashing value. Because the first and second signed entropy inputs are different, the resultant secret keys will be different from one another. In another example, changing the dynamic portion of a single device in a group of devices can function to disallow the single device to communicate with the other remaining devices in the group. Thus, these processes can be used to add or remove the device from a group, add or remove functionality or access to a service, add or remove hardware functionality within the device, and so forth—just to name a few.

In some embodiments, the method includes a step 210 of processing the one-time programmable key and the dynamic portion of the keyed hashing function with an HMAC function to create a secret key. As mentioned above, the secret key is unknown to the hardware component of the first device. In some embodiments, the first random number (OTP) and the second random number (signed entropy) are processed to create a resultant value.

Next, the method includes a step 212 of storing the secrete key in the vault.

In some embodiments, the method includes another optional step of transmitting the secret key to the RIS 104 in step 214. The secret key is thus symmetric with a stored key kept on the RIS 104.

The method can also include an optional step 216 of receiving a new or updated dynamic portion from the RIS 104. The method then includes a step 218 of re-processing the OTP key and updated dynamic portion to create an updated secret key. As mentioned above, the updated dynamic portion can include a new set of entropy bits, such as a random number. As this dynamic portion changes, a corresponding change in a behavior of the keyed hashing function changes producing a new secret key.

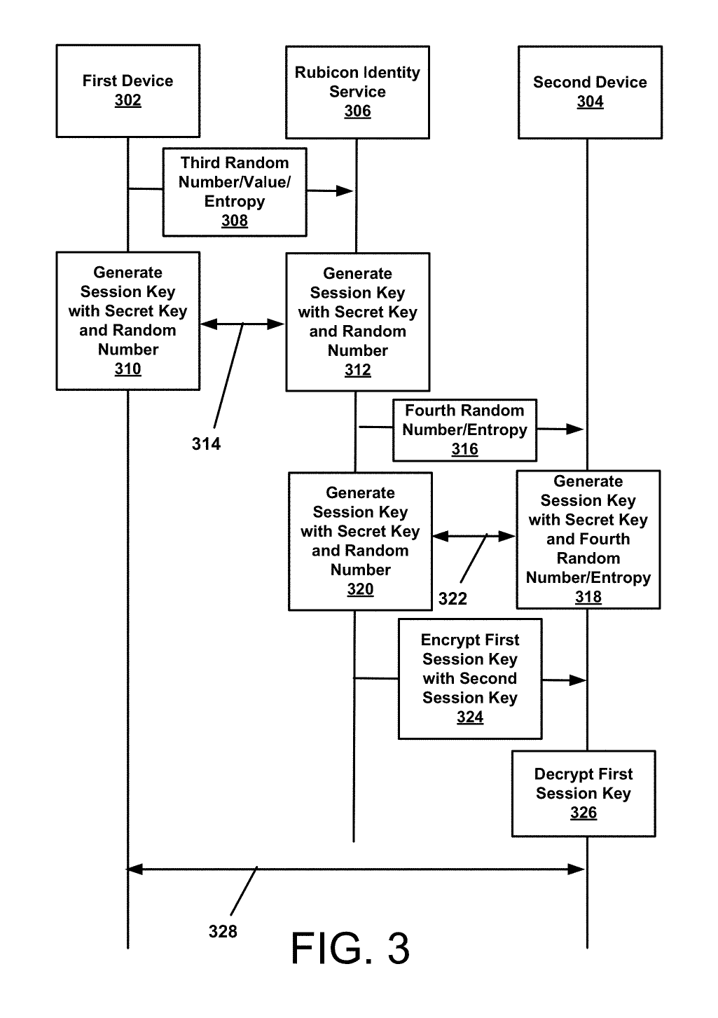

FIG. 3 illustrates an example signal flow diagram of a method for establishing a trust relationship between a first device 302 and a second device 304. This trust relationship is mediated by a rubicon identity service (RIS) 306.

Prior to the execution of this method, each device has been provisioned with a secret key in accordance with the embodiments described above.

In some embodiments, the method includes the first device 302 generating a third set of bits of entropy, such as a random number string. Again, for clarity, the first and second sets of bits of entropy were described above and used to generate the secret key.

In one embodiment, the method includes a step of transmitting to the RIS 306 the third set of bits of entropy in step 308. In a subsequent or contemporaneous step 310, a session key for the first device 302 is generated. This includes the first device 302 processing the third set of bits of entropy with the resident secret key using HMAC function in step 310.

The RIS 306 can utilize the third set of bits of entropy to generate an identical version of the session key created by the first device 302 in step 312. This is possible due to the fact that the secret key for the first device 302 is mirrored in the RIS 306 and the RIS 306 is likewise provisioned with AES.

When the session keys match, a secure connection 314 or trust relationship with the RIS 306 is created.

Next, the RIS 306 generates a fourth set of bits of entropy, such as a random number that is transmitted to the second device 304 in step 316. The second device 304 processes the fourth set of bits of entropy using its secret key and HMAC function to create a second session key in step 318. The RIS 306 also creates an identical session key to that which exists on the first device 302 using mirrored information of the second device 304.

Generally speaking, the session keys are secondary types of keys which are derived from the secret keys created on each of the devices in step 320. This creates a trusted path 322 and/or trusted relationship between the RIS 306 and second device 304.

To set up the trust relationship, the RIS 306 can encrypt the session key created by or for the first device 302 with the session key created by or for the second device 304. This can be accomplished using the resident AES functionality in the RIS 306.

This session key is referred to as the encrypted session key for clarity of description. Step 324 includes the encrypted session key being transmitted to the second device 304.

The second device 304 then decrypts the encrypted session key using its provisioned AES functionality to recover the first session key in step 326. The trust relationship can be established because the second device 304 has the session key created by the first device 302. This trust relationship is identified as path 328.

This trust relationship can be unilateral or bilateral. For example, the relationship can be defined such that the first device 302 trusts the second device 304, but that the second device 304 does not trust the first device 302. Thus, the first device 302 may receive data from the second device 304, but the second device 304 does not receive data from the first device 302.

FIG. 4 is a flowchart of an example method that is executed by a rubicon identity service. The method comprises the provision of dynamic portion of keyed hashing functions, the mirroring of secret device keys, and the creation of trust relationships between devices that each includes a symmetric secret key described herein.

In this method, upon initial device activation of a first device 102, a step 402 of receiving a request to obtain a dynamic portion of a keyed hashing function from the first device 102 is received. The request can comprise an OTP key for the first device 102 that was previously mirrored in the RIS 104. The request can also comprise a signature of the RIS 104 created by the first device 102. If the first device 102 is authenticated, the method includes a step 404 of transmitting the dynamic portion of the keyed hashing function to the first device 102.

Next, the method can comprise a step 406 of receiving a request to establish a trust relationship between the first device 102 and a second device 106. This request comprises a set of bits of entropy used to create a first session key by the first device 102. The first device 102 retains the first session key.

The method also comprises a step 408 of generating the first session key using the set of bits of entropy. This can include processing the set of bits of entropy with a symmetric version of the keyed hashing function for the first device 102 to create a first session key, the first device 102 having also created the first session key.

In some embodiments, a secure channel with the first device 102 using the first session key. In some embodiments, the method includes a step 410 of transmitting another set of bits of entropy to the second device 106. It will be understood that the second device 106 creating a second session key using the another set of bits of entropy. The RIS 104 also creates this same second session key that mirrors the one created by the second device 106 using the another set of bits of entropy.

Next, the method includes a step 412 of encrypting the second session key with the first session key, as well a step 414 of transmitting the encrypted session key to the second device 106. To be sure, the second device 106 can decrypt the encrypted session key to recover the first session key and establish a secure session with the first device 102.

The second device 106 can then share the first session key with the first device 102 as a means of authenticating the second device 106.

According to some embodiments, the present disclosure can implement both authentication of devices/objects according to the methods above, as well as authorization of the devices/objects in accordance with a pre-provisioned policy. Generally, the authentication and authorization methods described herein can be used to allow a node to be authenticated using the symmetric key methods and systems of the present disclosure. The node can then be authorized to take one or more actions based on the provisioned policy. To be sure, a node can comprise any object that is capable of performing a computing function. Examples include, but are not limited to, mobile devices, point of sale terminals, servers, cloud-based computing environments, smart devices (including but not limited to IoT devices), smart cards, and any other similar devices that are configured to receive and process data using embedded or otherwise provided algorithms.

A pre-provisioned authorization policy can define authorized actions that define, for example, how, where, when, or how much a node can operate. By way of example, a pre-provisioned authorization policy can allow an IoT device, such as a sensor module, to activate when the sensor module is operating at a temperature that is within a specified range. In another example, a node can include a mobile device, such as a smartphone, that is allowed to access a network only when the smartphone is within a specified geographical location or boundary (e.g., virtual geofence). For example, the smartphone may only be allowed to access an Enterprise network when the smartphone is within a building. This information is stored in the pre-provisioned authorization policy.

In some embodiments, the pre-provisioned authorization policy is embedded into the node during manufacturing, similarly to the OTP. The pre-provisioned authorization policy can also be stored in the vault or secret memory space on the node. In another embodiment, the pre-provisioned authorization policy is transmitted to the node after exchange of symmetric keys. For example, once the node is authenticated by a RIS, the RIS can pass the node the pre-provisioned authorization policy. In another embodiment, the pre-provisioned authorization policy can be shared between nodes in a session after authorization of the nodes through exchange of symmetric session keys.

In some embodiments, the present disclosure allows for selective enabling/disabling of hardware and/or application features on a node. By way of example, a cellular service can be enabled and/or disabled on a tablet device using a pre-provisioned authorization policy. In another example, a computing device having a plurality of computing cores can be controlled through use of a pre-provisioned authorization policy that allows additional or fewer cores to be used as authorized. This allows for enforcement of service and/or hardware level agreements at the device level through pre-provisioning of authorization policies.

To be sure, the aspects of pre-provisioning of an authorization policy can be effectuated through distribution of authorization policies to nodes prior to authentication of the nodes with a RIS, for example.

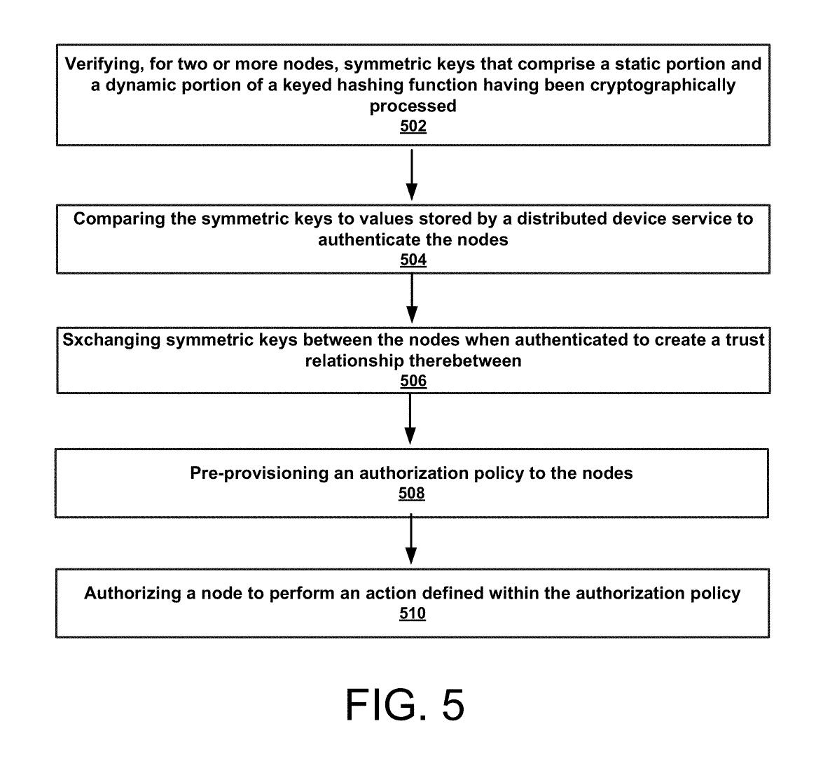

In more detail and with reference to FIG. 5, a method for both authenticating and authorizing nodes in accordance with the present disclosure includes various steps. In general, the nodes can include any computing-capable (either passive or active) devices. For example, nodes can include a smart card, a smart card reader, and a RIS that facilitates symmetric key exchange with each of the nodes and session key exchange between the nodes.

In various embodiments, the method comprises an initial method of authenticating nodes. The number of nodes authenticated can depend on the type of method being executed. In some embodiments, the nodes can include hundreds or potentially thousands of nodes such as IoT devices in a factory or enterprise network. In another embodiment the nodes can include as few as two devices, such as mobile devices that desire to establish an authenticated session allowing the devices to communicate with one another in a secure manner using encrypted session keys derived from symmetric keys exchanged between nodes and a RIS.

An authentication sub-method comprises a step 502 of verifying, for two or more nodes, symmetric keys that comprise a static portion and a dynamic portion of a keyed hashing function having been cryptographically processed. To be sure, each of the nodes has one of the symmetric keys. For example, a smart card can include an OTP key that is combined with a dynamic key from a RIS to create an encrypted key. This encrypted key is mirrored in the RIS when the RIS processes the OTP key and the dynamic key together.

The authentication sub-method also includes a step 504 of comparing the symmetric keys to values stored by a rubicon identity service to authenticate the nodes. When the RIS authenticates the nodes that desire to create a communication or other similar session, the method includes a step 506 of exchanging symmetric keys between the nodes when authenticated to create a trust relationship between the two or more nodes. In some embodiments, the RIS can mediate this exchange, whereas in other embodiments the nodes can exchange symmetric keys without using the RIS.

In some embodiments, the method can include a step 508 of pre-provisioning an authorization policy to the nodes. This method step could occur prior to the step 506 of exchanging symmetric keys between the nodes. In another embodiment, the step 508 can occur prior to step 502, such as when the node is pre-provisioned with an authorization policy when the node is manufactured. For example, a smartphone can be pre-provisioned with an authorization policy that defines when services and/or hardware on the smartphone can be accessed.

Next, the method includes a step 510 of authorizing a node to perform an action defined within the authorization policy. For example, the action could include unlocking access to a hardware component, such as a short range wireless module. In more detail, a smartphone is provisioned with a Bluetooth module, which is initially inaccessible. The smartphone also is provided with an authorization policy that defines when the Bluetooth module is authorized for use. For example, the authorization policy could allow the authorization policy Bluetooth module to be activated when a user of the smartphone pays for use of the Bluetooth module. In one or more embodiments this could be effectuated by the smartphone receiving a code from the RIS 104. This code is part of the authorization policy. When the code is received, the Bluetooth module is unlocked and available for use. Other similar methods for allowing access to hardware can be implemented.

These methods of symmetric key authorization and subsequent policy-based authorization can be used to create devices with numerous hardware and/or software features, where these features can be selectively activated and/or deactivated through use of an authorization policy. Thus, device manufacturers can create a single device that includes all desired and/or available hardware options, but that these options are accessible or inaccessible through the use of authorization policies. The device manufacturer need not manufacture devices with varying hardware components, which will improve manufacturing costs compared to device manufacturers that are required to create devices with different numbers of components to control hardware and/or service level usage by the device.

If unauthorized, the hardware components on a device of the present disclosure are inaccessible until authorized based on its authorization policy.

It will be understood that the same methods for selective hardware access can be applied for selectively granting access to software and/or applications that reside on a device or in a cloud service.

In another example implementation, a pre-provisioned authorization policy allows the action to be performed by the node when the node is within a virtual geofence boundary specified in the pre-provisioned authorization policy. By way of example, a tablet device is not allowed to access an application until the tablet device is located within a specific geographical area, which can be defined, for example, by geospatial coordinates. In another example, the geographical area includes being in range of a secure and/or trusted access point. For example, a banking application installed on the tablet device is only available when the tablet device is logged onto a secure home network.

In another embodiment, the pre-provisioned authorization policy allows the action to be performed by the node when the node is operating within a specified temperature range. By way of example, an engine is only allowed to operate when an engine temperature is in a safe operating temperature range. This safe operating temperature range is included in an authorization policy. Thus, the engine is only authorized to operate when the engine is within a safe operating temperature range, such as −20 degrees Fahrenheit to 220 degrees Fahrenheit. When the engine temperate exceeds 220 degrees Fahrenheit, the engine is instructed to shut down based on rules included in the authorization policy.

According to some embodiments, a pre-provisioned authorization policy allows the action to be performed by the node when the node is operating within any of a specified altitude range, a velocity range, an acceleration range, or combinations thereof. For example, a drone includes a wireless communication module, such as a cellular communication module. The pre-provisioned authorization policy can specify that the drone is not allowed to transmit data unless the drone is above 5,000 feet.

In another example, a vehicle having an onboard WiFi access point can have the onboard WiFi access point disabled when the vehicle is traveling above a specified velocity threshold. Again, this feature is mediated in its availability (e.g., on/off) based on information included in a pre-provisioned authorization policy.

Again, each of these examples provided above involves authorization subsequent to or contemporaneous in time with the authentication of the device or node using a symmetric key exchange process described herein. Thus, the nodes can be provisioned with an advanced encryption standard that is used to create a secret key from a static portion and a dynamic portion of a secret key. The nodes are provided with the static portion (OTP key) and a dynamic portion, which are processed together using AES to create a symmetric encrypted key. As mentioned above, session keys can be derived from these symmetric encrypted keys.

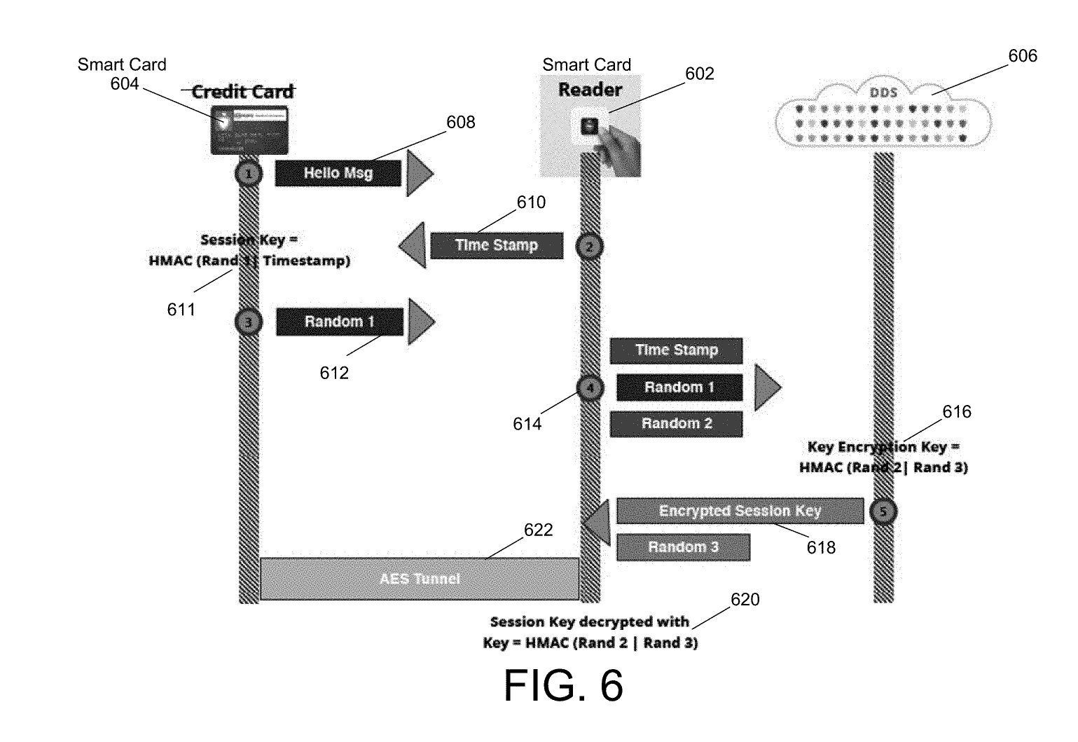

FIG. 6 is a signal flow diagram that illustrates the use of an example system that includes a plurality of nodes that can be authenticated and authorized according to the present disclosure.

For purposes of clarity and brevity, the following example system will include the use of three computing nodes, such as a smart card, a smart card reader, and a RIS. The smart card reader 602 is referred to as a first computing node; the smart card 604 is referred to as a second computing node. The RIS 606 is referred to as a third computing node.

In some embodiments, the first computing node (smart card reader 602) is pre-provisioned with an OTP key and an authorization policy. In some embodiments, the smart card reader 602 receives a request from a second computing node (smart card 604). For example, when the smart card 604 is inserted into the smart card reader 602 (or otherwise in communication through contactless exchange), a request message is transmitted to the smart card reader 602 in step 608.

In step 610, smart card reader 602 forwards a first timestamp in a response message to the smart card 604. Next, the smart card 604 will generate a session key using a keyed-hash message authentication code (HMAC function) to process a first set of bits of entropy and the first timestamp in step 611. The first set of bits of entropy can be stored as a OTP key on the smart card 604, such as a randomly generated number.

The smart card 604 transmits the random number to the smart card reader 602 in step 612.

The smart card reader 602 can transmit the first timestamp, the first set of bits of entropy (e.g., OTP key), and a second set of bits of entropy to the RIS 606. The second set of bits of entropy in step 614. The second set of bits of entropy can include, for example, another random number that is generated by the smart card reader 602.

The RIS 606 receives the second timestamp, along with the first and second sets of bits of entropy. The RIS 606 can then utilize another HMAC encryption algorithm to process both the second bits of entropy in combination with the third bits of entropy (another random number generated by the RIS 606) to create an encrypted session key in step 616. Step 618 includes transmitting the encrypted session key to the card reader 602, along with the third bits of entropy.

In step 620 the session key is decrypted using an HMAC function on the card reader 602 to recover the session key. The session key is then used to create an AES tunnel between the smart card 604 and the card reader 602 in step 622.

A transaction can then be effectuated between the smart card 604 and the card reader 602 through the AES tunnel 622. In this embodiment, the process allows for bi-directional authentication. Once established, sensitive data can be exchanged such as credit card numbers, social security numbers, personal identification numbers, expiration dates, zip codes, and other sensitive data. The sensitive data is stored on the smart card and made accessible to the card reader 602 only when the card 604 and reader 602 have been authenticated.

In one embodiment, aspects of authorization can be implemented, such as time of day constraints. For example, an authorization policy stored on the smart card 604 can restrict use of the smart card 604 to certain hours of the day. If the timestamps 610 indicate that the smart card 604 is being used outside of the time of day constraints, the smart card 604 is not authorized. While these embodiments can be used for credit card transaction processing, the same aspects can be applied to, for example, logical and/or physical security governed by the use of a smart card.

In another example, a smart card policy could comprise a transaction limit threshold. For example, the authorization policy on the smart card 604 only allows for the smart card 604 to request processing of transactions up to a certain amount for a day, week, month, or any other specified time frame.

In some embodiments, the system can implement aspects of symmetric key and session key generation, OTP and dynamic key setting, key synchronization, and user authentication. These systems and methods are effective in reducing susceptibility to replay malware, spoofing, denial-of-service attacks, man-in-the-middle attacks, and cryptanalysis, as well as other malicious behavior.

A smart card reader can include a stand-alone reader and/or a reader integrated into another system, such as a point of sale system. In some embodiments, the system can implement or utilize a payment gateway that is implemented as a network abstraction layer.

The RIS 606 can facilitate authentication services (using the static/dynamic data processed with HMAC function), authorization through authorization policies, settlement of transactions, data analysis for reporting, and user interfaces (UIs) for controlling the use of the system.

In one specific embodiment, the system of FIG. 6 can include an entire architecture for creating, linking, and managing digital cash transactions. The system facilitates secure key generation and provisioning to a physical token (smart card 604), with each card having a unique and collision-free identity (in the smart card space). These identities and corresponding keys will be synced and managed in the cloud (RIS 606). User identity is optionally bound to the smart card 604.

Other states of information can be bound to this two or three-tuple identity, such as currency values. A similar process for generating point of sale devices with secure identities can be implemented. A system for authenticating and authorizing payment transactions is also contemplated.

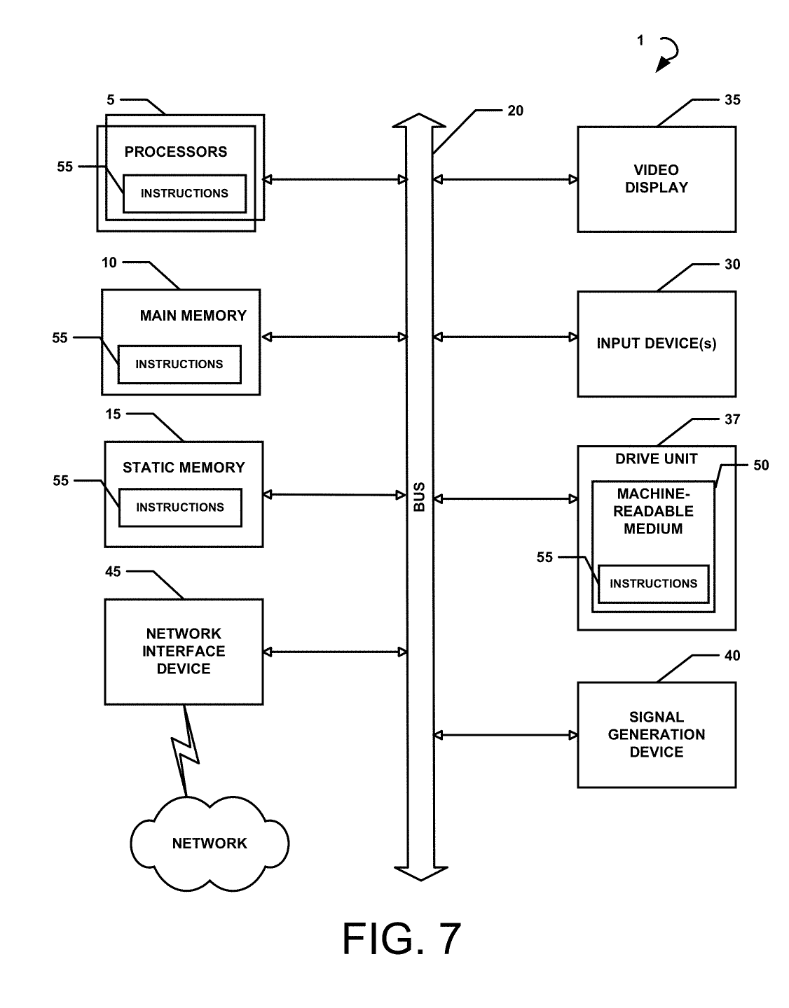

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 or MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output (I/O) devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without deviating from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems), and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function or act specified in the flowchart and/or block diagram block or blocks.

The computer program instructions may also be uploaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Moreover, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data or control information) to the second entity regardless of the type (analog or digital) of those signals. It is further noted that various figures (including component diagrams) shown and discussed herein are for illustrative purpose only and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
authenticating nodes by:
verifying symmetric keys that comprise a static portion and a dynamic portion of a keyed hashing function having been cryptographically processed, each of the nodes having one of the symmetric keys;
comparing the symmetric keys to values stored by a distributed device service; and
exchanging symmetric keys between the nodes when authenticated;
pre-provisioning an authorization policy to the nodes; and
authorizing a node of the nodes to perform an action defined within the authorization policy.

2. The method according to claim 1, wherein the pre-provisioned authorization policy allows the action to be performed by the node when the node is within a virtual geofence boundary specified in the pre-provisioned authorization policy.

3. The method according to claim 1, wherein the pre-provisioned authorization policy allows the action to be performed by the node when the node is operating within a specified temperature range.

4. The method according to claim 1, wherein the pre-provisioned authorization policy allows the action to be performed by the node when the node is operating within any of a specified altitude range, a velocity range, an acceleration range, or any combinations thereof.

5. The method according to claim 1, wherein one node of the nodes is a smart card and a second node of the nodes is a smart card reader.

6. The method according to claim 1, wherein one node of the nodes is a mobile device and a second node of the nodes is any of a cellular network, another mobile device, an enterprise network, a private network, or any combinations thereof.

7. The method according to claim 1, further comprising provisioning the nodes with an advanced encryption standard that is used to create the secret key from the static portion and the dynamic portion, and wherein the one-time programmable key comprises a first set of bits of entropy.

8. The method according to claim 7, further comprising upon initiation of one node of the nodes, requesting from the rubicon identity service the dynamic portion of the keyed hashing function, which comprises a second set of bits of entropy, wherein as the second set of bits of entropy of changes, a behavior of the keyed hashing function changes to create an updated secret key.

9. The method according to claim 1, further comprising:
processing the OTP key with an HMAC function to create a signature of the OTP key; and
transmitting the OTP key and signature to the rubicon identity service.

10. The method according to claim 1, wherein the secret keys are mirrored in the rubicon identity service as an identifier for the nodes and a means for generating encrypted session keys for the nodes.

11. The method according to claim 9, wherein a unilateral or bilateral trust relationship can be established between a portion of the nodes using the secret keys based on derivation of session keys therefrom.

12. The method according to claim 10, further comprising:
creating a first session key in the vault of one node of the nodes that corresponds to an identical session key generated by the rubicon identity service for the one node; and
creating a second session key in the vault of a second node of the nodes that corresponds to an identical session key generated by the rubicon identity service for the second node.

13. A system, comprising:
a first computing node configured to:
receive a request from a second computing node;
forward a first timestamp in a response message to the second computing node;
generate, by the second computing node, a session key using a keyed-hash message authentication code to process a first set of bits of entropy and the first timestamp;
the second computing node configured to:
transmit the first timestamp, the first set of bits of entropy, and a second set of bits of entropy to a third computing node;
the third computing node configured to:
generate, by the third computing node, an encryption session key using another keyed-hash message authentication code to process the second set of bits of entropy and a third set of bits of entropy;
and
transmit the encryption session key to the second computing node along the third set of bits of entropy; and
wherein the second computing node decrypts the session key using the encryption key and the third set of bits of entropy to recover the session key.

14. The system according to claim 13, wherein the first computing node and the second computing node are communicatively coupled over an advanced encryption service tunnel.

15. The system according to claim 13, wherein the third computing node comprises a rubicon identity service.

16. The system according to claim 15, wherein the first computing node is any of a smart card or a mobile device, and the second computing node is a smart card reader.

17. The system according to claim 16, wherein a unilateral or bilateral trust relationship can be established between the first node and the second using secret keys based on derivation of session keys therefrom.

18. The system according to claim 16, wherein the smart card comprises a one-time programmable key, further wherein the one-time programmable key is synced to the third node.

19. The system according to claim 16, wherein the one-time programmable key is embedded into the smart card when created.

20. The system according to claim 13, wherein the session key is a symmetric session key.
